(19) United States
(12) Patent Application Publication
(10) Pub. No.: US 2016/0334883 A1
(43) Pub. Date: Nov. 17, 2016

(54) GESTURE INPUT APPARATUS AND VEHICLE INCLUDING OF THE SAME

(71) Applicant: HYUNDAI MOTOR COMPANY, Seoul (KR)

(72) Inventor: Sung Un KIM, Yongin-si (KR)

(21) Appl. No.: 14/839,832

(22) Filed: Aug. 28, 2015

(30) Foreign Application Priority Data
May 12, 2015 (KR) 10-2015-0065680

(51) Int. Cl. G06F 3/03; B60K 37/02; G06F 3/01

(52) U.S. Cl. CPC G06F 3/0304; G06F 3/017; B60K 37/02; B60K 2350/1052

(57) ABSTRACT

A gesture input apparatus includes infrared light emitting diodes (IR-LEDs), light guide bars configured to uniformly distribute light generated by the IR-LEDs and emit light through the front of the gesture input apparatus, and light receiving sensors installed adjacent to the light guide bars and configured to concentrate light reflected by an object disposed over the front of the gesture input apparatus.

CROSS-REFERENCE TO RELATED APPLICATION(S)

This application claims the benefit of Korean Patent Application No. 2015-0065680, filed on May 12, 2015 in the Korean Intellectual Property Office, the disclosure of which is incorporated herein by reference.

### TECHNICAL FIELD

Embodiments of the present disclosure relate to an infrared light emitting diode-based gesture input apparatus and a vehicle including the same.

### BACKGROUND

A driver may control a vehicle by using a gesture via gesture recognition. A variety of techniques have been suggested for gesture recognition. For example, gesture recognition may be performed using a motion sensor attached to a human body, using a biological signal of the human body, or by image processing using a webcam.

The gesture recognition techniques using the motion sensor and biological signal are inconvenient since a separate device needs to be attached to the human body, and the gesture recognition technique through image processing using the webcam requires a processing chip and memory for data processing, resulting in an increase in manufacturing costs.

### SUMMARY

Therefore, it is an aspect of the present disclosure to provide a gesture input apparatus configured to uniformly emit light through the front of a light guide bar and a vehicle including the same.

Additional aspects of the disclosure will be set forth in part in the description which follows and, in part, will be obvious from the description, or may be learned by practice of the disclosure.

In accordance with one aspect of the present disclosure, a gesture input apparatus includes an infrared light emitting diode (IR-LED), a light guide bar configured to uniformly distribute light generated by the IR-LED and emit light through the front of the gesture input apparatus, and a light receiving sensor installed adjacent to the light guide bar and configured to concentrate light reflected by an object disposed over the front of the gesture input apparatus.

A plurality of light receiving sensors may be arranged at predetermined intervals adjacent to a plurality of light guide bars respectively.

A plurality of light receiving sensors and a plurality of light guide bars may be alternatingly arranged.

The light guide bar may have a cylindrical shape or polygonal pillar shape.

The light guide bar may have a light scattering pattern configured to emit light totally reflected in the light guide bar toward the front of the light guide bar.

The gesture input apparatus may further include a controller configured to control driving times of the IR-LED and the light receiving sensor.

The controller may detect a gesture of a user by using information about an amount of light received by the light receiving sensor while sequentially driving a plurality of IR-LEDs.

The gesture input apparatus may further include an analog-to-digital converter configured to convert brightness information received from the light receiving sensor into a digital signal.

In accordance with another aspect of the present disclosure, a vehicle including a gesture input apparatus, wherein the gesture input apparatus includes an infrared light emitting diode (IR-LED), a light guide bar configured to uniformly distribute light generated by the IR-LED and emit light through the front of the gesture input apparatus, and a light receiving sensor installed adjacent to the light guide bar and configured to concentrate light reflected by an object disposed over the front of the gesture input apparatus.

A plurality of light receiving sensors may be arranged at predetermined intervals adjacent to a plurality of light guide bars respectively.

A plurality of light receiving sensors and a plurality of light guide bars may be alternatingly arranged.

The light guide bar may have a cylindrical shape or polygonal pillar shape and have a light scattering pattern configured to emit light totally reflected in the light guide bar toward the front of the light guide bar.

The vehicle may further include a controller configured to control driving times of the IR-LED and the light receiving sensor.

The controller may detect a gesture of a user by using information about an amount of light received by the light receiving sensor while sequentially driving a plurality of IR-LEDs.

The vehicle may further include an analog-to-digital converter configured to convert brightness information received from the light receiving sensor into a digital signal.

The gesture input apparatus may be installed in at least one position selected from the group consisting of around an audio video navigation device of a vehicle, around a centralized control system of the vehicle, or at a steering wheel of the vehicle.

In accordance with still another aspect of the present disclosure, a gesture input apparatus includes a user input device for receiving user instructions, an infrared light emitting diode (IR-LED) and a light sensor disposed on an edge of the user input device, and a controller controlling operations of the IR-LED and the light sensor, and transmitting a signal to the user input device upon determining a changed of light sensed by the light sensor. The user input device may perform a predetermined function upon receiving the signal from the controller.

The gesture input apparatus may further include a light guide bar uniformly distributing light emitted from the IR-LED.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is an exterior view of a vehicle according to an embodiment of the present disclosure;

FIG. 2 is an interior view of a vehicle according to an embodiment of the present disclosure;

FIG. 3 is a diagram illustrating a gesture input apparatus according to an embodiment of the present disclosure installed around an audio video navigation (AVN) device;

FIG. 4 is a diagram illustrating a gesture input apparatus according to an embodiment of the present disclosure installed around a centralized control system;

FIG. 5 is a diagram illustrating a gesture input apparatus according to an embodiment of the present disclosure installed at a steering wheel;

FIG. 6 is a diagram illustrating a structure of a gesture input apparatus according to an embodiment of the present disclosure;

FIG. 7 is an enlarged diagram of a light guide bar of the gesture input apparatus of FIG. 6;

FIG. 8 is a diagram illustrating a structure of a gesture input apparatus according to another embodiment of the present disclosure;

FIGS. 9 to 12 are diagrams for describing principles of operation of a gesture input apparatus according to an embodiment of the present disclosure;

FIG. 13 is a diagram illustrating an example of manipulating a user interface of an AVN device according to an embodiment of the present disclosure; and

FIGS. 14A and 14B are diagrams illustrating examples of creating screens of the user interface to which a proximity sensing technique is applied.

### DETAILED DESCRIPTION

Reference will now be made in detail to the embodiments of the present disclosure, examples of which are illustrated in the accompanying drawings, wherein like reference numerals refer to like elements throughout.

Hereinafter, a vehicle and a method of controlling the same will be described in detail with reference to the accompanying drawings.

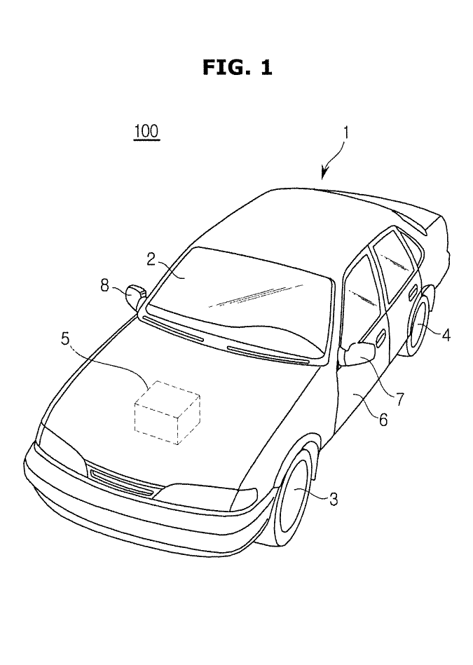

FIG. 1 is an exterior view of a vehicle 100 according to an embodiment of the present disclosure.

Referring to FIG. 1, the vehicle 100 includes a body 1 defining an external appearance of the vehicle 100, a front glass 2 configured to provide a driver sitting in the vehicle 100 with a forward view of the vehicle 100, wheels 3 and 4 configured to move the vehicle 100, a driving device 5 configured to rotate the wheels 3 and 4, doors 6 configured to shield the inside of the vehicle 100 from the outside, and side mirrors 7 and 8 configured to provide the driver with rear views of the vehicle 100.

The front glass 2 is disposed at a front upper portion of the body 100 to allow the driver sitting in the vehicle 100 to acquire visual information about the forward view of the vehicle 100 and is also called a windshield glass. According to an embodiment, the windshield glass may serve as a head-up display, and the head-up display may provide a variety of information including navigation information, turn by turn (TBT) information, and the like.

The wheels 3 and 4 include front wheels 3 disposed at front portions of the vehicle 100 and rear wheels 4 disposed at rear portions of the vehicle 100. The driving device 5 may provide rotational force to the front wheels 3 or the rear wheels 4 such that the body 1 moves forward or backward. The driving device 5 may include an engine configured to generate the rotational force by combustion of fossil fuels or a motor configured to generate the rotational force by receiving power from an electric condenser (not shown).

The doors 6 are pivotally coupled to the body 1 at left and right sides and the driver may get into the vehicle 100 by opening the door 6, and the inside of the vehicle 100 may be shielded from the outside by closing the door 6. The doors 6 may be provided with windows through which the inside the vehicle 100 is visible and vice versa. According to an embodiment, only one of the inside and the outside of the vehicle 100 may be visible through the windows, and the windows may be opened and closed.

The side mirrors 7 and 8 include a left side mirror 8 disposed at the left side of the body 1 and a right side mirror 7 disposed at the right side of the body 1 and allow the driver sitting in the vehicle 100 to acquire visual information about side views and rear views of the vehicle 100.

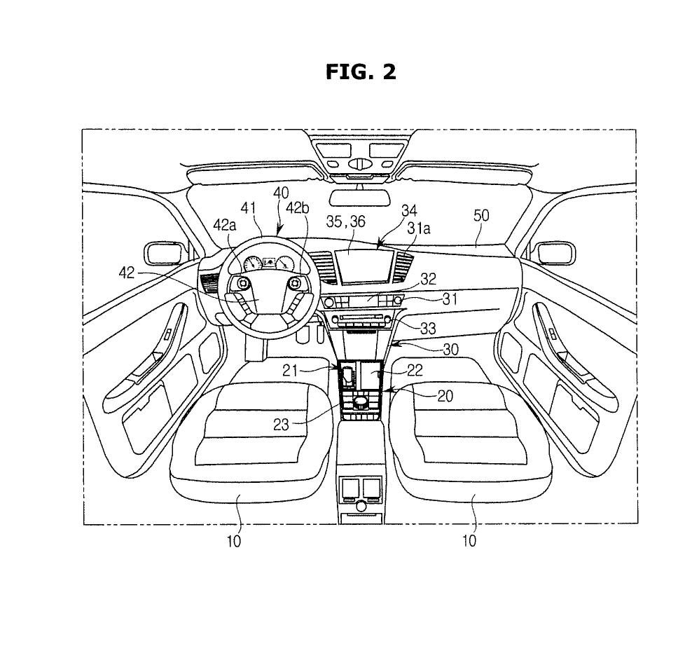

FIG. 2 is an interior view of the vehicle 100 according to an embodiment of the present disclosure. Referring to FIG. 2, the vehicle 100 includes seats 10 on which a driver and passengers sit and a dashboard 50 provided with a gear box 20, a center fascia 30, and a steering wheel 40.

The gear box 20 may be provided with a transmission lever 21 to change gears of the vehicle 100 and a touch pad 22 to control performance of functions of the vehicle 100. Also, a dial control unit 23 may be selectively installed in the gear box 20. In this case, the dial control unit 23 may serve as a centralized control system. A gesture input apparatus according to an embodiment of the present disclosure may be installed around the dial control unit 23, which will be described later.

The center fascia 30 may be provided with an air conditioner 31, a clock 32, and an audio device 33, an audio video navigation (AVN) device 34, and the like.

The air conditioner 31 maintains the inside of the vehicle 100 in a clean state by controlling temperature, humidity, and cleanness of air, and air flow inside the vehicle 100. The air conditioner 31 may include at least one discharge port 31a installed in the center fascia 30 and configured to discharge air. The center fascia 30 may be provided with a button or dial to control the air conditioner 31. A user such as the driver may control the air conditioner 31 by using the button disposed at the center fascia 30.

The clock 32 may be disposed near the button or dial to control the air conditioner 31.

The audio device 33 may include a control panel on which a plurality of buttons to perform functions of the audio device 33 are disposed. The audio device 33 may provide a radio mode to provide radio functions and a media mode to reproduce audio files of various storage media including the audio files.

The AVN device 34 may be embedded in the center fascia 30 of the vehicle 100. The AVN device 34 is a device performing an overall operation of audio functions, video functions, and navigation functions in accordance with a user's manipulation. The AVN device 34 may include an input unit 35 to receive a user's command regarding the AVN device 34 and a display 36 to display a screen related to the audio functions, video functions, or navigation functions. The gesture input apparatus according to the present embodiment may be installed around the AVN device 34. Accordingly, the user may manipulate the AVN device 34 only using a gesture without removing eyes from the road if the drive needs to manipulate the AVN device 34 while driving the vehicle 100, and this will be described later.

The steering wheel 40, which is a device to control a driving direction of the vehicle 100, includes a rim 41 gripped by the driver and a spoke 42 connected to a steering device of the vehicle 100 and connecting the rim 41 with a hub of a rotating shaft for steering. According to an embodiment, the spoke may include manipulators 42a and 42b to control various devices of the vehicle 100, for example, the audio device. The gesture input apparatus according to the present embodiment may be installed at the rim 41 of the steering wheel 40. Thus, the user may control the head-up display provided on the front glass 30 by only using a gesture when the driver needs to manipulate the head-up display while driving the vehicle 100, and this will be described later.

Also, the dashboard 50 may further include an instrument cluster to display various driving-related information such as a driving speed of the vehicle 100, a revolution per minute (RPM) of an engine RPM, a fuel level, or the like, and a glove compartment for miscellaneous storage.

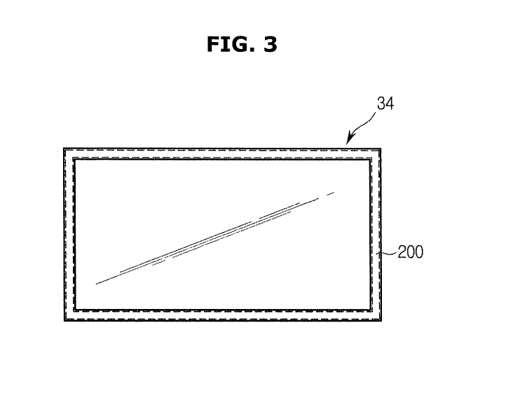

Hereinafter, a gesture input apparatus 200 and a vehicle 100 including the same according to an embodiment of the present disclosure will be described in more detail with reference to FIGS. 3 to 5.

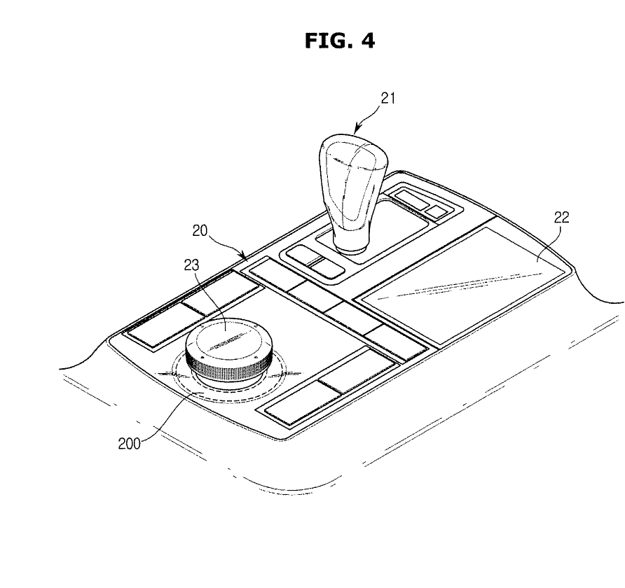

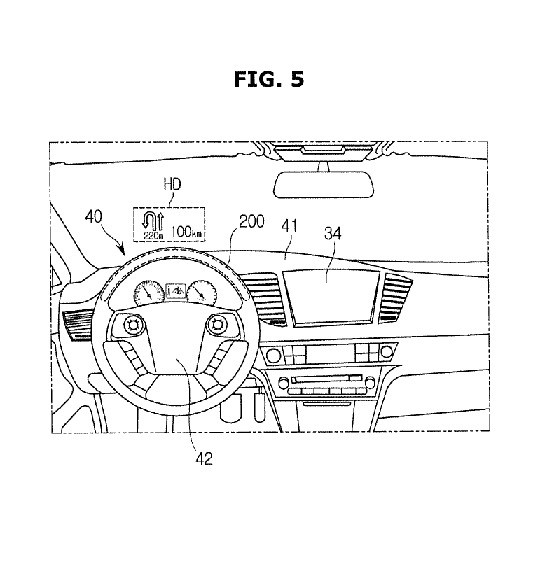

FIG. 3 is a diagram illustrating the gesture input apparatus 200 installed around the audio video navigation (AVN) device 34. FIG. 4 is a diagram illustrating the gesture input apparatus 200 installed around the dial control unit 23. FIG. 5 is a diagram illustrating the gesture input apparatus 200 installed at the steering wheel 40.

Referring to FIG. 3, the gesture input apparatus 200 may be installed around the AVN device 34, more particularly, along edges of the AVN device 34. The gesture input apparatus 200 installed along the edges of the AVN device 34 may receive a gesture input of a user to manipulate the AVN device 34. Thus, the user may manipulate a menu by only using a gesture without removing eyes from the road when the driver needs to manipulate the AVN device 34 while driving the vehicle 100.

Referring to FIG. 4, the gesture input apparatus 200 may be installed around the dial control unit 23 of the gear box 20, more particularly, along a circumference of the dial control unit 23. The gesture input apparatus 200 installed along the circumference of the dial control unit 23 may receive a gesture input of the user to manipulate the dial control unit 23. The gesture input apparatus 200 installed around the dial control unit 23 may also receive a gesture input of the user to manipulate the AVN device 34.

Referring to FIG. 5, the gesture input apparatus 200 is installed at the steering wheel 40 to control the head-up display HD shown on the windshield glass. The head-up display is a system used for safe and convenient driving of the driver by minimizing a change of gaze of the driver by projecting main driving-related information on the front windshield glass. The vehicle 100 may provide main driving-related information including TBT information to the driver via the head-up display.

The gesture input apparatus 200 installed at the rim 41 of the steering wheel 40 may receive a gesture input of the user to manipulate contents displayed on the head-up display. According to an embodiment, the gesture input apparatus 200 may also be installed around the instrument cluster of the rear surface of the windshield glass or embedded in the ceiling of the driver's seat.

The installation position of the gesture input apparatus 200 according to an embodiment is described above. Then, configuration of the gesture input apparatus 200 will be described in more detail. Hereinafter, the gesture input apparatus 200 installed along the edges of the AVN device 34 as illustrated in FIG. 3 will be described by way of example for descriptive convenience.

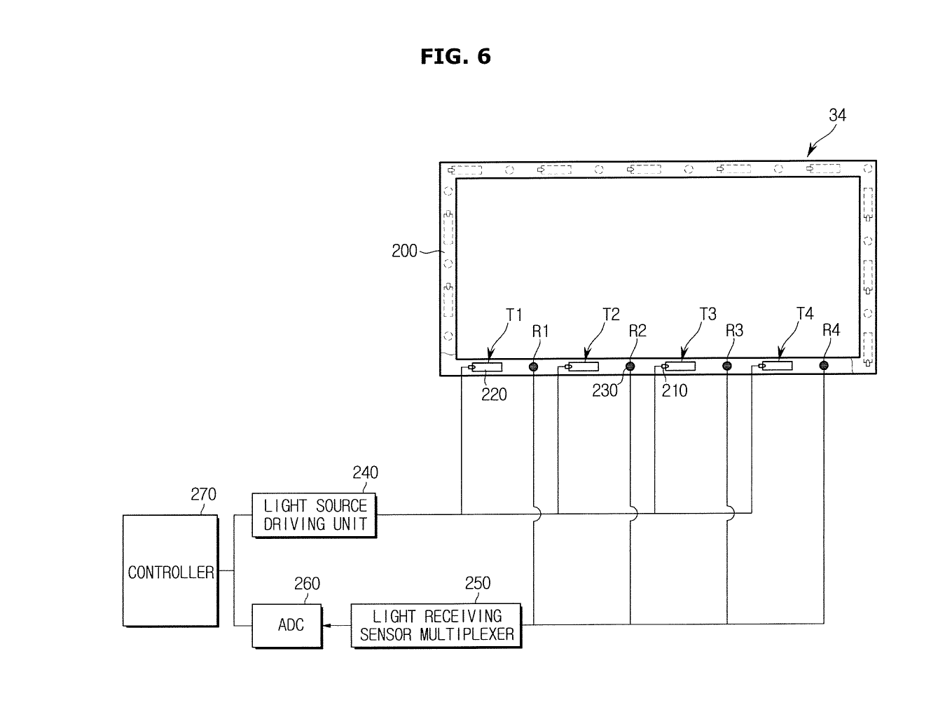

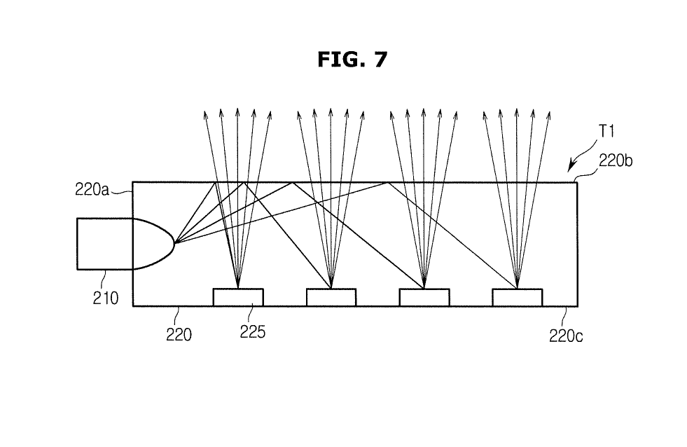

FIG. 6 is a diagram illustrating a structure of the gesture input apparatus 200 according to an embodiment of the present disclosure. FIG. 7 is an enlarged diagram of a light guide bar 220 of the gesture input apparatus 200 of FIG. 6.

Referring to FIG. 6, the gesture input apparatus 200 according to an embodiment may be installed on the rear surface of an outer frame of the AVN device 34. Infrared light emitting diodes (IR-LEDs) 210, light guide bars 220 configured to uniformly distribute light generated by the IR-LEDs 210 and emit the light through the front of the gesture input apparatus 200, and light receiving sensors 230 installed adjacent to the light guide bars 220 and configured to concentrate light reflected by an object disposed over the front of the gesture input apparatus 200 may be arranged on the rear surface of the outer frame along the edges of the AVN device 34.

The IR-LED 210 may be arranged at a lateral side of the light guide bar 220 and emit infrared light having a wavelength of 900 to 1000 nm.

The IR-LEDs 210 may be connected to a controller 270 via a light source driving unit 240. The controller 270 may simultaneously or sequentially drive the IR-LEDs 210 in accordance with a driving method of the gesture input apparatus 200, and this will be described later.

In general, light generated by a diode has a radiation pattern. Thus, when light is provided using the IR-LED 210 without using a separate device, the front of the gesture input apparatus 200 may have a dead zone at which light does not arrive. When there is a dead zone where light does not reach as described above, a gesture of the user may not be detected at a predetermined angle. Thus, a device that uniformly distributes light toward the front of the gesture input apparatus 200 is required in order to increase accuracy of gesture sensing. In the gesture input apparatus 200 according to an embodiment, the light guide bar 220 is disposed on the front surface of the IR-LED 210 to convert light generated by the IR-LED 210 into the same form as light generated by a surface light source.

The IR-LEDs 210 and the light guide bars 220 may be coupled with each other to form surface light source modules, and the surface light source modules may be arranged along the edges of the AVN device 34 at predetermined intervals together with the light receiving sensors 230. Hereinafter, a plurality of surface light source modules may be referred to as T1, T2, T3, and T4, respectively, and a plurality of light receiving sensors 230 may be referred to as R1, R2, R3, and R4, respectively, for descriptive convenience.

Referring to FIG. 7, the light guide bar 220 according to an embodiment may have an incidence surface 220a on which light is incident, a light emitting surface 220b through which the incident light is emitted, and a reflection surface 220c facing the light emitting surface 220b. The reflection surface 220c may have a light emission pattern 225 to emit the incident light. Meanwhile, the light guide bar 220 may also have a cylindrical shape or other polygonal pillar shapes different from that illustrated in FIG. 7.

The IR-LED 210 may be disposed on a lateral side of the light guide bar 220, and light generated by the IR-LED 210 may be incident on the incidence surface 220a disposed at the lateral side of the light guide bar 220. Among light beams incident upon the incidence surface 220a, light beams arriving at the reflection surface 220c may be totally reflected in the light guide bar 220. Among light beams arriving at the reflection surface 220c, light beams arriving at the light emission pattern 225 of the reflection surface 220c may be emitted through the light emitting surface 220b of the light guide bar 220. As a result, light generated by the IR-LED 210 is converted into the same form as light of a surface light source by the light guide bar 220 and emitted through the front of the gesture input apparatus 200.

The light receiving sensors 230 may be arranged adjacent to the respective light guide bars 220 at predetermined intervals to concentrate light reflected by the object disposed over the front of the gesture input apparatus 200. In this regard, the object may include a gesture input unit such as a hand of the user.

The light receiving sensors 230 may be arranged at predetermined intervals to be adjacent to the light guide bar 220, respectively. The light receiving sensors 230 and the light guide bars 220 may be alternatingly arranged. When the light receiving sensors 230 and the light guide bars 220 are alternatingly arranged, the AVN device 34 may have a thinner frame thereby obtaining an aesthetically appealing design.

The light receiving sensor 230 may be a phototransistor, more particularly, a phototransistor exhibiting a relatively high response to light in an infrared wavelength range. The phototransistor, which is a photoelectric conversion device including an npn junction or a pnp junction, may convert energy of light into electrical energy. The phototransistor according to an embodiment may detect a gesture of the user based on the principle in which voltage and current changes in proportion to intensity of light per unit area when light is incident on a base electrode.

The light receiving sensors 230 may be connected to a single output line via a light receiving sensor multiplexer 250. The light receiving sensor multiplexer 250 may serve as a data selector that outputs a single data value using data acquired from a plurality of light receiving sensors 230.

Data output from the light receiving sensor multiplexer 250 may be processed by an analog-digital converter (ADC) 260 to be transmitted to the controller 270. The ADC 260, which is a device converting an electric analog signal into a digital signal, may convert information about amounts of light received from the light receiving sensors 230 into a digital signal and output the converted digital signal to the controller 270.

The controller 270 may control times of driving the IR-LEDs 210 and the light receiving sensors 230. Particularly, the controller 270 may control the IR-LEDs 210 to operate sequentially and detect the gesture of the user by collecting information of the amounts of light received by the light receiving sensors 230.

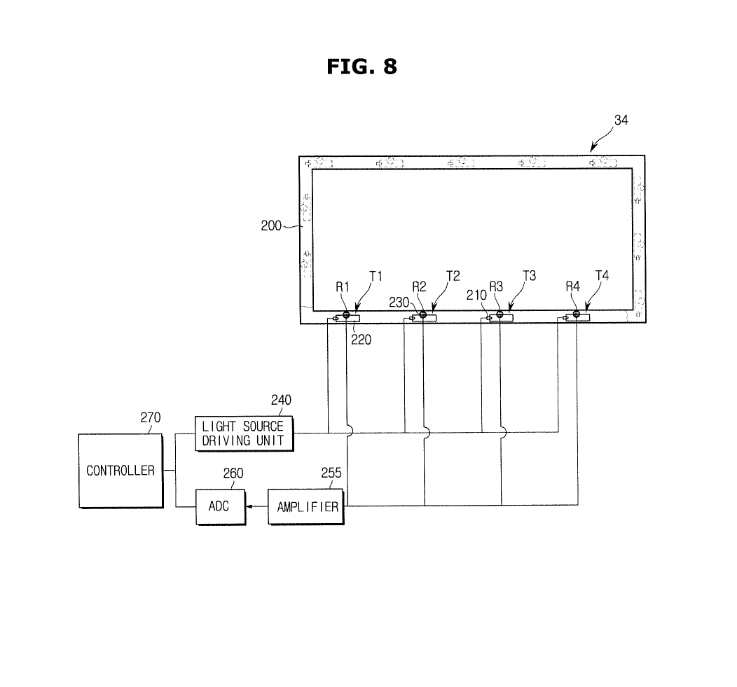

FIG. 8 is a diagram illustrating a structure of a gesture input apparatus 200 according to another embodiment of the present disclosure.

Referring to FIG. 8, the gesture input apparatus 200 may also be installed on the rear surface of an outer frame of the AVN device 34. The IR-LEDs 210, the light guide bars 220 configured to uniformly distribute light generated by the IR-LEDs 210 and emit the light through the front of the gesture input apparatus 200, and the light receiving sensors 230 installed adjacent to the respective light guide bars 220 and configured to concentrate light reflected by an object disposed over the front of the AVN device 34 may be arranged on the rear surface of the outer frame along the edges of the AVN device 34. The structures of the IR-LEDs 210 and the light guide bars 220 of the gesture input apparatus 200 according to the present embodiment are the same as those of the IR-LEDs 210 and the light guide bars 220 described above with reference to FIGS. 6 and 7. Hereinafter, the present embodiment will be described based on differences from those of FIGS. 6 and 7.

The gesture input apparatus 200 according to the present embodiment is different from the gesture input apparatus 200 of FIG. 6 in terms of arrangement of the light receiving sensors 230. Referring to FIG. 8, in the gesture input apparatus 200 according to the present embodiment, the light receiving sensor 230 may be disposed on the light emitting surface 220b of the light guide bar 220. That is, since the light receiving sensor 230 is disposed on a light emitting surface of the light guide bar 220 instead of being disposed between two light guide bars 220, the light receiving sensor 230 may concentrate light emitted from the light emitting surface 220b of the light guide bar 220 and reflected by the object disposed over the front of the gesture input apparatus 200 more efficiently. As a result, accuracy of the gesture recognition may be increased.

Meanwhile, the light receiving sensors 230 may be connected to an amplifier 255. The amplifier 255 is a device that amplifies an input signal and outputs the amplified signal. Information about the amounts of light collected by the light receiving sensors 230 may be amplified by the amplifier 255 and transmitted into the ADC 260. The information about the amounts of light transmitted to the ADC 260 may be converted into digital signals by the ADC 260, and the converted digital signals may be transmitted to the controller 270.

The controller 270 may control times of driving the IR-LEDs 210 and the light receiving sensors 230. Particularly, the controller 270 may control the IR-LEDs 210 to operate sequentially or simultaneously and detect the gesture of the user by collecting information of the amounts of light received by the light receiving sensors 230.

The structures of the gesture input apparatus 200 are described above. Hereinafter, principles of operation of the gesture input apparatus 200 will be described in detail.

The gesture input apparatus 200 may detect a gesture of the user by using properties of light emitted and reflected by the object disposed over the front of the gesture input apparatus. In other words, when a proceeding direction of infrared light generated by the IR-LED 210 is changed by a user's hand or an object, the light receiving sensor 230 may concentrate the reflected light, and the controller 270 may detect the gesture of the user by processing the light concentrated by the light receiving sensor 230.

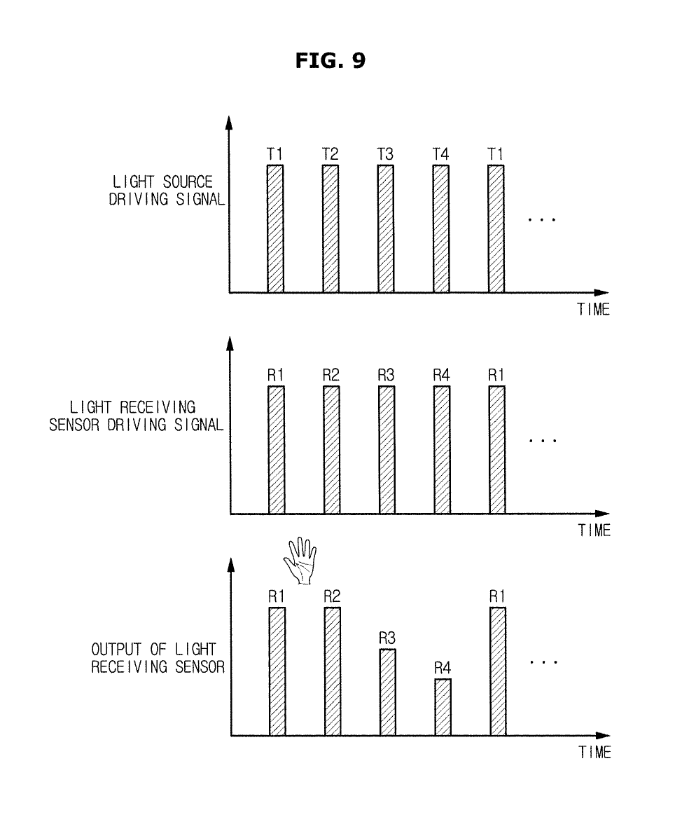

The controller 270 may control times of driving the IR-LEDs 210 and the light receiving sensors 230. The controller 270 may control times of plurality of driving the IR-LEDs 210 and the plurality of light receiving sensors 230 such that the IR-LEDs 210 and the light receiving sensors 230 operate continuously or discontinuously. FIGS. 9 to 12 are diagrams for describing times of driving the plurality of IR-LEDs 210 and light receiving sensors 230. For descriptive convenience, four surface light source modules T1, T2, T3, and T4 and four light receiving sensors R1, R2, R3, and R4 corresponding thereto are illustrated for describing a driving method of the IR-LEDs 210 and the light receiving sensors 230.

Referring to FIG. 9, the controller 270 may determine a position of the user's hand by sequentially driving the plurality of surface light source modules T1, T2, T3, and T4 and sequentially collecting output values of the light receiving sensors 230. In other words, since the times of driving the IR-LEDs 210 respectively included in the plurality of surface light source modules T1, T2, T3, and T4 are differently set, the light receiving sensors 230 may detect light incident on and reflected by the user's hand when the user's hand is located at a given position.

In this case, an output value of one light receiving sensor 230 disposed adjacent to the user's hand may be higher than output values of the other light receiving sensors 230, and the controller 270 may determine that the user's hand is located near the light receiving sensor 230 outputting the higher output value. For example, when the user's hand is located near the light receiving sensors R1 and R2, output values of the light receiving sensors R1 and R2 may be higher than output values of the light receiving sensors R3 and R4. In this case, the controller 270 may determine that the user's hand is located near the light receiving sensors R1 and R2.

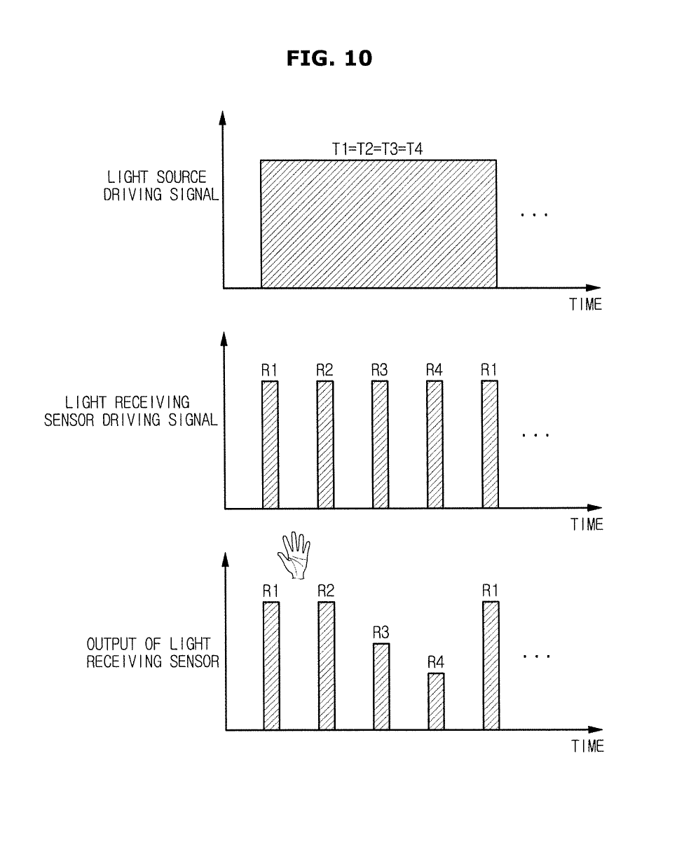

Referring to FIG. 10, the controller 270 may determine the position of the user's hand by simultaneously driving the plurality of surface light source modules T1, T2, T3, and T4 and sequentially collecting output values of the light receiving sensors 230. The method of FIG. 10 is different from that of FIG. 9, in that the plurality of IR-LEDs 210 of the plurality of surface light source modules T1, T2, T3, and T4 are simultaneously driven.

Also, according to the method of FIG. 10, when the user's hand is located at a given position, the light receiving sensors R1, R2, R3, and R4 may detect light incident on the user's hand and reflected thereby. In this case, an output value of one light receiving sensor 230 near the user's hand may be higher than output values of the other light receiving sensors 230.

Upon examining output values of the light receiving sensors 230 illustrated in FIG. 10, it is confirmed that output values of the light receiving sensors R1 and R2 are higher than output values of the light receiving sensors R3 and R4. In this case, the controller 270 may determine that the user's hand is located near the light receiving sensors R1 and R2.

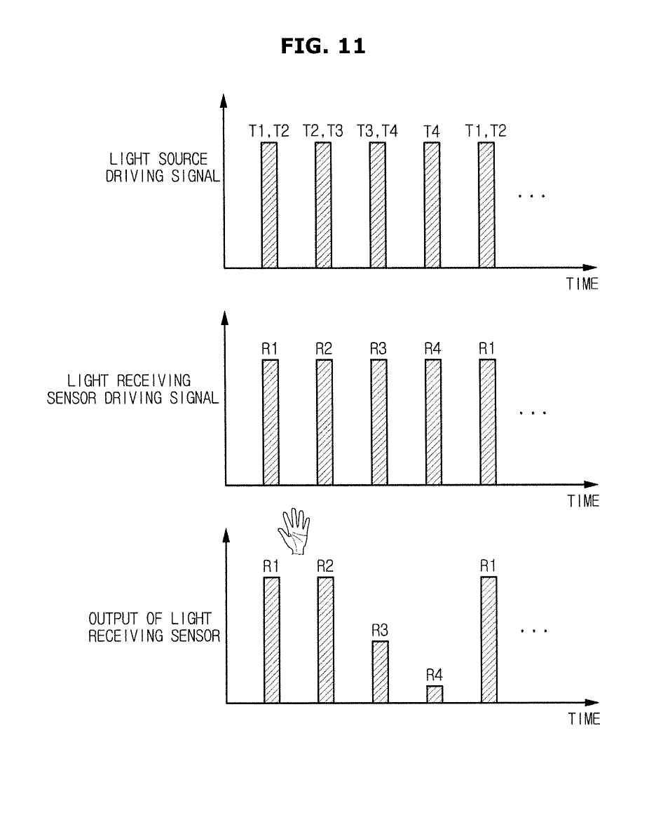

Then, referring to FIG. 11, the controller 270 may determine the position of the user's hand by driving surface light source modules adjacent to a given light receiving sensors 230 and collecting light reflected by the object when light output from the driven surface light source module is reflected by the object. For example, the controller 270 may drive the surface light source modules T1 and T2 adjacent to the light receiving sensor R1 and may drive the surface light source modules T2 and T3 adjacent to the light receiving sensor R2.

Since a plurality of IR-LEDs 210 are driven with respect to a single light receiving sensor 230 according to the present embodiment, sensitivity may be improved compared with driving the IR-LEDs 210 and the light receiving sensors 230 in one-to-one relationship.

Upon examining output values of the light receiving sensors 230 as illustrated in FIG. 11, it is confirmed that output values of the light receiving sensors R1 and R2 are higher than output values of the light receiving sensors R3 and R4. In this case, the controller 270 may determine that the user's hand is located near the light receiving sensors R1 and R2.

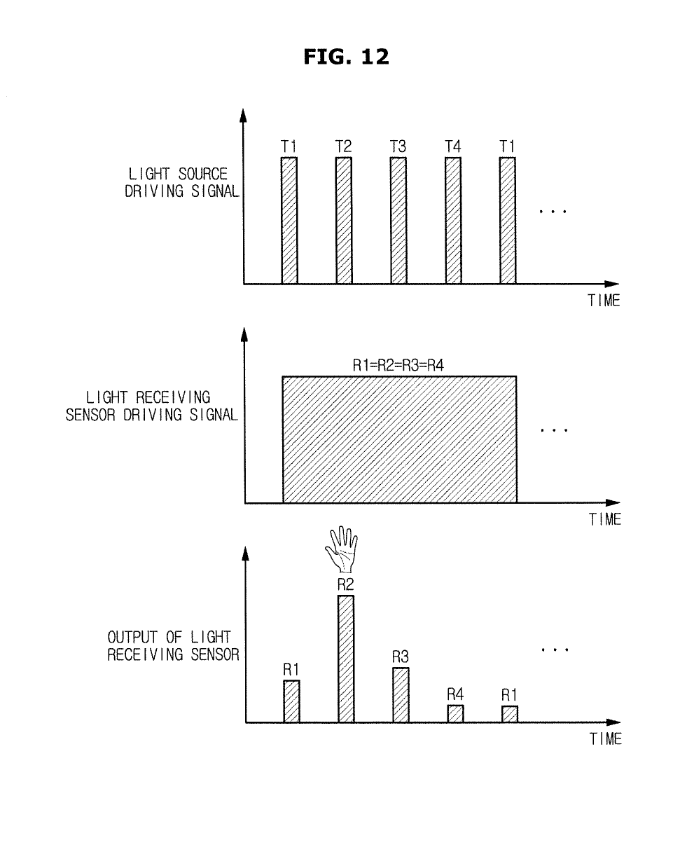

Referring to FIG. 12, the controller 270 may determine the position of the user's hand by sequentially driving the plurality of surface light source modules T1, T2, T3, and T4, and simultaneously collecting output values of the plurality of light receiving sensors R1, R2, R3, and R4. When the user's hand is located over a given light receiving sensor 230, an output value of the light receiving sensor 230 may be greater than a predetermined value. In this case, the controller 270 may determine that the user's hand is located over the light receiving sensor 230.

Upon examining output values of the light receiving sensors 230 as illustrated in FIG. 12, it is confirmed that an output value of the light receiving sensor R2 is higher than output values of the light receiving sensors R1, R3, and R4. In this case, the controller 270 may determine that the user's hand is located near the light receiving sensor R2.

The principles of operation of the gesture input apparatus 200 according to an embodiment are described above. Hereinafter, application of the gesture input apparatus 200 in the vehicle 100 will be described.

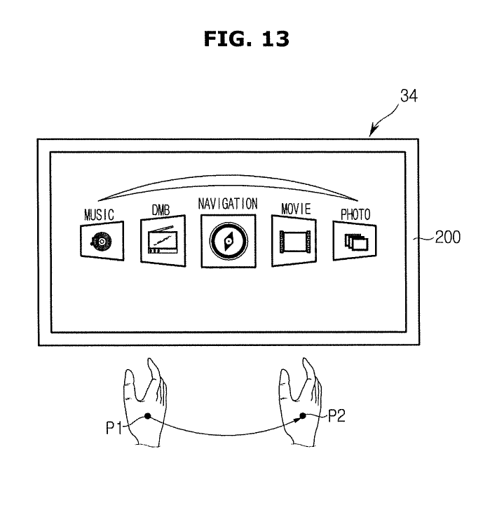

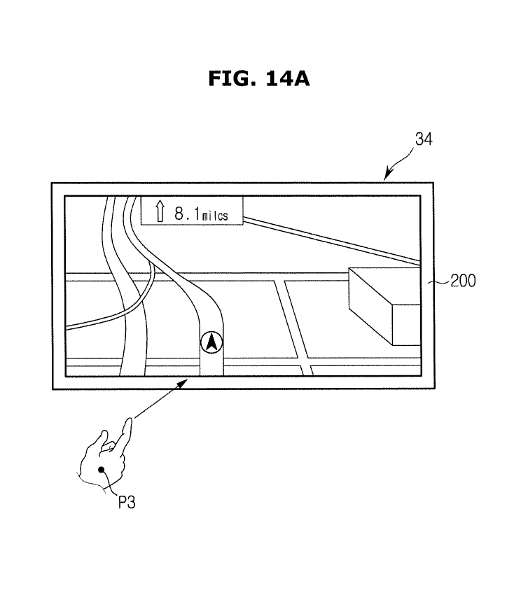

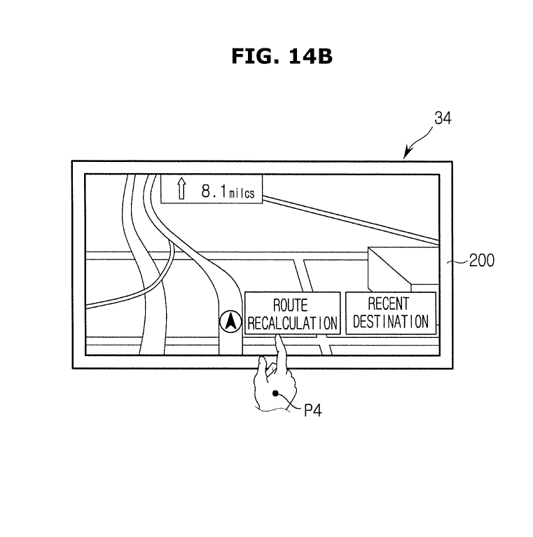

FIG. 13 is a diagram illustrating an example of manipulating a user interface of the AVN device 34 according to an embodiment of the present disclosure. FIGS. 14A and 14B are diagrams illustrating examples of creating screens of the user interface to which a proximity sensing technique is applied.

Referring to FIG. 13, when the user's hand is detected at a first position P1 and then detected at a second position P2, the gesture input apparatus 200 may recognize a gesture of the user moving from the first position P1 to the second position P2.

Thus, the user may manipulate the menu by only using a gesture without removing eyes from the road when the driver needs to manipulate the AVN device 34 while driving the vehicle 100.

Although a lateral movement is illustrated as the gesture in FIG. 13, a vertical movement or tapping may be used as the gesture in the same manner. By using such gestures, the driver may control functions frequently used such as functions of the air conditioner or turning on/off of the radio.

Referring to FIGS. 14A and 14B, when the user's hand is detected at a third position P3 and then detected at a fourth position P4, the gesture input apparatus 200 according to an embodiment may recognize a gesture of the user moving from the third position P3 to the fourth position P4. In this regard, the fourth position P4 may be closer to the gesture input apparatus 200 than the third position P3, and thus the gesture input apparatus 200 may recognize a proximity gesture of the user.

The vehicle 100 according to an embodiment of the present disclosure may provide a user interface including gesture recognition applied to a display of the AVN device 34 through the proximity sensing technique according to a user's intention. For example, when a user's hand approaches the AVN device 34 in a navigation map mode of the AVN device 34 to manipulate the AVN device 34, the vehicle 100 may control a display unit of the AVN device 34 to provide a touch manipulation user interface. The touch manipulation user interface may include a route recalculation user interface and recent destination user interface, without being limited thereto.

As is apparent from the above description, the gesture input apparatus and the vehicle including the same according to embodiments of the present disclosure may be used to expand an beam angle to the front of the light guide bar, resulting in reducing dead zones of gesture detection.

Although a few embodiments of the gesture input apparatus 200 and the vehicle 100 including the same according to the present disclosure have been shown and described, it would be appreciated by those skilled in the art that changes may be made in these embodiments without departing from the principles and spirit of the disclosure, the scope of which is defined in the claims and their equivalents.

What is claimed is:

1. A gesture input apparatus comprising:
an infrared light emitting diode (IR-LED);
a light guide bar configured to uniformly distribute light generated by the IR-LED and emit light through the front of the gesture input apparatus; and
a light receiving sensor installed adjacent to the light guide bar and configured to concentrate light reflected by an object disposed over the front of the gesture input apparatus.

2. The gesture input apparatus according to claim 1, comprising a plurality of light receiving sensors arranged at predetermined intervals adjacent to a plurality of light guide bars respectively.

3. The gesture input apparatus according to claim 1, comprising a plurality of light receiving sensors and a plurality of light guide bars alternatingly arranged.

4. The gesture input apparatus according to claim 1, wherein the light guide bar has a cylindrical shape or polygonal pillar shape.

5. The gesture input apparatus according to claim 1, wherein the light guide bar has a light scattering pattern configured to emit light totally reflected in the light guide bar toward the front of the light guide bar.

6. The gesture input apparatus according to claim 1, further comprising a controller configured to control driving times of the IR-LED and the light receiving sensor.

7. The gesture input apparatus according to claim 6, wherein the controller detects a gesture of a user by using information about an amount of light received by the light receiving sensor while sequentially driving a plurality of IR-LEDs.

8. The gesture input apparatus according to claim 1, further comprising an analog-to-digital converter configured to convert brightness information received from the light receiving sensor into a digital signal.

9. The gesture input apparatus according to claim 1, wherein the gesture input apparatus is installed in at least one position selected from the group consisting of around an audio video navigation device of a vehicle, around a centralized control system of the vehicle, or at a steering wheel of the vehicle.

10. A vehicle comprising a gesture input apparatus, wherein the gesture input apparatus comprises:
an infrared light emitting diode (IR-LED);
a light guide bar configured to uniformly distribute light generated by the IR-LED and emit light through the front of the gesture input apparatus; and
a light receiving sensor installed adjacent to the light guide bar and configured to concentrate light reflected by an object disposed over the front of the gesture input apparatus.

11. The vehicle according to claim 10, comprising a plurality of light receiving sensors arranged at predetermined intervals adjacent to a plurality of light guide bars respectively.

12. The vehicle according to claim 10, comprising a plurality of light receiving sensors and a plurality of light guide bars alternatingly arranged.

13. The vehicle according to claim 10, wherein the light guide bar has a cylindrical shape or polygonal pillar shape and has a light scattering pattern configured to emit light totally reflected in the light guide bar toward the front of the light guide bar.

14. The vehicle according to claim 10, further comprising a controller configured to control driving times of the IR-LED and the light receiving sensor.

15. The vehicle according to claim 14, wherein the controller detects a gesture of a user by using information about an amount of light received by the light receiving sensor while sequentially driving a plurality of IR-LEDs.

16. The vehicle according to claim 10, further comprising an analog-to-digital converter configured to convert brightness information received from the light receiving sensor into a digital signal.

17. The vehicle according to claim 10, wherein the gesture input apparatus is installed in at least one position selected from the group consisting of around an audio video navigation device of a vehicle, around a centralized control system of the vehicle, or at a steering wheel of the vehicle.

18. A gesture input apparatus comprising:
a user input device for receiving user instructions;
an infrared light emitting diode (IR-LED) and a light sensor disposed on an edge of the user input device; and
a controller controlling operations of the IR-LED and the light sensor, and transmitting a signal to the user input device upon determining a changed of light sensed by the light sensor,
wherein the user input device performs a predetermined function upon receiving the signal from the controller.

19. The gesture input apparatus according to claim 18, further comprising a light guide bar uniformly distributing light emitted from the IR-LED.
